(19) United States
(12) Patent Application Publication
(10) Pub. No.: US 2011/0313633 A1
(43) Pub. Date: Dec. 22, 2011

(54) DEVICE FOR NAVIGATING A MOTOR VEHICLE AND A METHOD OF NAVIGATING THE SAME

(76) Inventors: Gary M. Nath, Alexandria, VA (US); Dwight C. Olson, San Diego, CA (US)

(21) Appl. No.: 12/818,947

(22) Filed: Jun. 18, 2010

(51) Int. Cl. G08G 1/0968; G01S 19/42; G01C 21/36

(52) U.S. Cl. 701/70; 701/117; 701/119

(57) ABSTRACT

A method and system for navigation of a motor vehicle with reference to current traffic conditions in an area are presented. The navigation of the motor vehicle includes transmitting signals by a signal transceiver to a navigation unit in the motor vehicle, the signals include at least (a) current velocity information of sampling vehicles in the area or (b) current positional information of the sampling vehicles in the area; computing by the navigation unit at least one of the current velocity information and the current positional information to provide a reference value; and issuing by the navigation unit a warning of a traffic incident in the area if the reference value is smaller than a predetermined value.

### BACKGROUND OF THE INVENTION

1. Field of the Invention

The present subject matter relates generally to navigating a motor vehicle in a route, and more specifically to navigating the motor vehicle with reference to real-time traffic conditions in a specific area of consideration in the route.

2. Related Art

On-vehicle navigation systems are usually stand-alone applications wherein the traffic data are static and difficult to be dynamically updated. As a consequence, the optimal routes proposed by the navigation system are accurate only under ideal traffic conditions. The stand-alone versions cannot take into account current traffic jam conditions or real time emergencies. Hence, even when a so-called “optimal route” is found, it may not be a usable solution in real-time situations and can only be used as a general recommendation.

Other systems rely on electronic and optical sensors situated at various key locations to measure and update the current traffic loads. These systems are typically costly to install and maintain. Also, to be effective, they must be distributed over large sectors of roads. Still other real time traffic control systems utilize real time field information typically gathered from various service vehicles such as traffic police, ambulances, road maintenance teams, etc., which is usually transmitted by radio to the control center and from there broadcasted to the public. However, since human input is involved in the collection of the information, the accuracy is not always reliable.

### SUMMARY OF THE INVENTION

The present subject matter provides a system and method for navigation of a motor vehicle with reference to current traffic conditions in an area. The method for navigation of the motor vehicle includes transmitting signals by a signal transceiver to a navigation unit in the motor vehicle, the signals includes: (a) current velocity information of sampling vehicles in the area and (b) current positional information of the sampling vehicles in the area. The method also includes computing a reference value by the navigation unit based on at least one of the current velocity information and the current positional information; and issuing, by the navigation unit, a warning of a traffic incident in the area if the reference value is smaller than a predetermined value that represents at least one of historical velocity information and historical positional information associated with the area in a normal traffic condition.

According to an aspect, the subject matter includes displaying current velocities of the sampling vehicles based on the current velocity information such that any two sampling vehicles in the area are displayed with two visual objects of a same type if their velocities belong to a same speed zone, and the two sampling vehicles are displayed with two visual objects of two different types if their velocities belong to different speed zones.

According to another aspect of the subject matter, the two visual objects of two different types have two different colors.

According to a further aspect of the subject matter, the warning includes at least (a) a visual symbol; (b) an alarming sound; (c) a vibration; or (d) a voice notification.

According to a further aspect of the subject matter, the reference value is computed based on at least (a) an average value of the current velocities of the sampling vehicles in the area; (b) a lowest value among the current velocities of the sampling vehicles in the area; or (c) an average value of lowest n velocities among the current velocities of the sampling vehicles in the area.

According to a further aspect of the subject matter, the reference value is computed based on at least (a) an average value of distances between the sampling vehicles in the area; (b) a lowest value among the distances between the sampling vehicles in the area; or (c) an average value of lowest n distances among the distances between the sampling vehicles in the area.

According to a further aspect of the subject matter, the signals include the current velocity information of the sampling vehicles in the area, and the step of computing by the navigation unit is performed for the current velocity information, the method further including: determining an optimal route to a desired destination by the navigation unit such that an estimated travelling time along the optimal route has a lowest value compared to estimated travelling times along a plurality of alternative routes to the destination, the estimated travelling time along the route being calculated by the navigation unit based on both statistical traffic data for the route and the reference value; and displaying the optimal route to the desired destination.

According to a further aspect of the subject matter, the signal transceiver is a satellite and the navigation unit is installed with a Global Positioning System (GPS) module.

According to a further aspect of the subject matter, the navigation of the motor vehicle further includes: determining the sampling vehicles by sampling a plurality of vehicles in the area, each of the plurality of vehicles having a GPS module, the area being defined by at least (a) a predetermined radius or (b) a sampling block having a predetermined length along a route on which the sampling vehicles are.

According to a further aspect of the subject matter, the sampling vehicles are sampled in such a way that the sampling vehicles do not include a stopped vehicle.

According to a further aspect of the subject matter, the area is located at a predetermined distance ahead of the motor vehicle in a route, and the warning is issued, the method further includes: transmitting speed control signals to the motor vehicle by the navigation unit to instruct the motor vehicle to adjust its velocity to a lower speed that is equal to or within a predetermined deviation from the reference value.

According to a further aspect of the subject matter, the navigation of the motor vehicle further includes displaying the area by the navigation unit with a single color that is determined based on the current velocity information of the sampling vehicles.

According to a further aspect of the subject matter, a method of navigating a motor vehicle, includes: receiving signals that include at least (a) current velocity information of sampling vehicles in an area or (b) current positional information of the sampling vehicles in the area; computing a reference value based upon at least one of the current velocity information and the current positional information; and issuing a warning of a traffic incident in the area if the reference value is smaller than a predetermined value that represents at least one of historical velocity information and historical positional information associated with the area in a normal traffic condition.

According to a further aspect of the subject matter, a motor vehicle navigating system, includes: a signal transceiver that is configured to transmit signals to a motor vehicle, the signals including at least (a) current velocity information of sampling vehicles in the area or (b) current positional information of the sampling vehicles in the area; and a navigation unit connected to the motor vehicle, which comprises a non-transitory computer-readable medium that stores data for implementing: computing a reference value based upon at least one of the current velocity information and the current positional information; and issuing a warning of a traffic incident in the area if the reference value is smaller than a predetermined value that represents at least one of historical velocity information and historical positional information associated with the area in a normal traffic condition.

According to a further aspect of the subject matter, a device for navigating a motor vehicle, includes a non-transitory computer-readable medium that stores data for implementing: receiving signals that include at least (a) current velocity information of sampling vehicles in an area or (b) current positional information of the sampling vehicles in the area; computing at least one of the current velocity information and the current positional information to provide a reference value; and issuing a warning of a traffic incident in the area if the reference value is smaller than a predetermined value that represents at least one of historical velocity information and historical positional information associated with the area in a normal traffic condition.

According to a further aspect of the subject matter, a method of navigating a motor vehicle with reference to current traffic conditions in an area, includes: transmitting signals by a signal transceiver to a navigation unit in the motor vehicle, the signals including at least (a) current velocity information of sampling vehicles in the area or (b) current positional information of the sampling vehicles in the area; computing a reference value by the navigation unit based upon at least one of the current velocity information and the current positional information; and issuing, by the navigation unit, a warning of a traffic incident in the area if the reference value is smaller than a predetermined value that is determined by at least one selected from the group consisting of: a predetermined percentage of a speed limit applied to the area; the speed limit applied to the area subtracted by a predefined fixed number; and a fixed value determined according to a type of a road in which the area is located.

The subject matter of the present application provides a real time traffic guidance system, which is capable of providing an optimal route from the present position of a vehicle to a desired target destination when traffic jams may be present, thereby reducing the burden upon the driver when the vehicle is traveling at high speeds on unfamiliar roads. Thereafter the optimal route found is communicated to the driver and displayed on the vehicle's computer screen featuring the digital map of the relevant region and/or via audio instructions.

The travel time between two road intersections A and B is the sum of travel times for all sections of roads connecting A and B on the shortest route either by the minimal time criterion, or by some other criterion. Then in order to be able to compute a travel time between two positions on a map, one must be able to determine travel times for all sections of roads connecting those positions, or road intersections close to them. In the standard solution (an autonomous or stand-alone on-vehicle application), a route is computed by a mathematical optimization algorithm while travel times are computed as distances divided by maximal allowed speeds. While being simple, such solutions have an obvious shortcoming in that they do not take into account the real conditions on the roads and therefore can serve only as a guidance suggestion. Obviously, a true real time system should collect, store and make use of the following kinds of data:

1) Temporary changes in road conditions known in advance like closed roads under construction, traffic reroutes, etc.;

2) Regular predictable changes like everyday slowdowns in rush hours;

3) Sudden unpredictable changes such traffic accidents, traffic congestion due to sudden and drastic changes in traffic arrangements because of visiting dignitaries, etc.

The system according to the present subject matter is built around an idea of collecting and processing information that describes all those changing conditions.

Initially, the travel time is theoretical travel time but as the time goes by and observational data are being collected and processed, it is replaced by empirical travel time reflecting realistic travel conditions, and on particular occasions by current travel times, which reflect sudden and unpredictable changes in traffic conditions. Those travel times are being measured and periodically broadcasted by the signal transceiver to end-users where they are entered into the databases of the on-vehicle navigation units for future use.

On receiving a request from a driver for a shortest route to a particular destination, the end-user on-vehicle navigation unit applies an optimization procedure for computing an optimal route while making use of updated by the transceiver travel times for individual sections of roads. Thereafter, the optimal route is communicated to the driver either visually on the computer map, or auditorilly through a sequence of voice instructions.

### BRIEF DESCRIPTION OF THE DRAWINGS

The above and other aspects of the subject matter will be apparent with reference to the examples in the following description and with reference to the accompanying drawings.

FIG. 1 shows a navigation system for a motor vehicle with reference to current traffic conditions in accordance with the subject matter.

FIG. 2 is a flow chart that shows issue of a warning if there is a traffic incident in a route to a destination desired by a driver.

FIG. 3A shows a navigation unit in accordance with the subject matter, which displays an area with a single color based on an average velocity of sampling vehicles; and

FIG. 3B shows the navigation unit that displays the sampling vehicles with visual objects of different colors depending upon a speed zone to which each vehicle belongs.

FIG. 4 shows a primary route to a desired destination computed based on statistical data stored in the navigation unit, and an alternative route to the destination computed based on both the statistical data stored in the navigation unit and real-time traffic data obtained from a transceiver.

### TERMS IN USE

The terms used in this application may be understood as follows:

(1) A transceiver is generally understood as a combination transmitter and receiver in a single unit. In this application, the signal transceiver can be a satellite, an aircraft, or a signal control station either on the ground or in the air, which includes a server unit with analogue/digital link to a navigation unit.

(2) A navigation unit is generally understood as a unit giving directions to other locations along roads for a user. In this application, the navigation unit may be equipped with a Global Positioning System (GPS) module, a Radio Frequency (RF) transmitter, or any other kinds of wired or wireless signaling module, including wired/wireless internet module. For example, the navigation unit can be an independent navigation device, a mobile telephone or a mobile internet device such as a “Droid®” type mobile unit. The Droid (WCDMA/GSM version: Motorola Milestone) is an Internet and multimedia enabled smart phone designed by Motorola, which runs Google's Android operating system. The brand name Droid is a trademark of Lucas film licensed to Verizon Wireless.

(3) The Global Positioning System (GPS) is a space-based global navigation satellite system that provides reliable location and time information in all weather and at all times and anywhere on or near the Earth where there is an unobstructed line of sight to four or more GPS satellites.

### DETAILED DESCRIPTION OF THE INVENTION

A goal of the present subject matter is to provide a real time travel navigation system capable of handling a driver's request for a shortest route to any destination. At any point of the journey the driver can enter a request for alternative route and will receive an updated route reflecting the real time traffic situation directly on his display panel. The information will also be updated by visual and audio instructions, and driver's vehicle position will be displayed dynamically on the display navigation unit. Another goal is to provide the driver with a tool for strategic trip planning. By entering alternate times for future trips and comparing their travel time estimates for the same destination, the driver receives an option to select a trip proposal ideally suited for his needs. The navigation system also enables the user to manually, or by verbal commands, to update and customize his information database and adapt it to his personal needs and requirements.

The figures are diagrammatic and not drawn to scale. In the figures, elements which correspond to elements already described have the same reference numerals or characters.

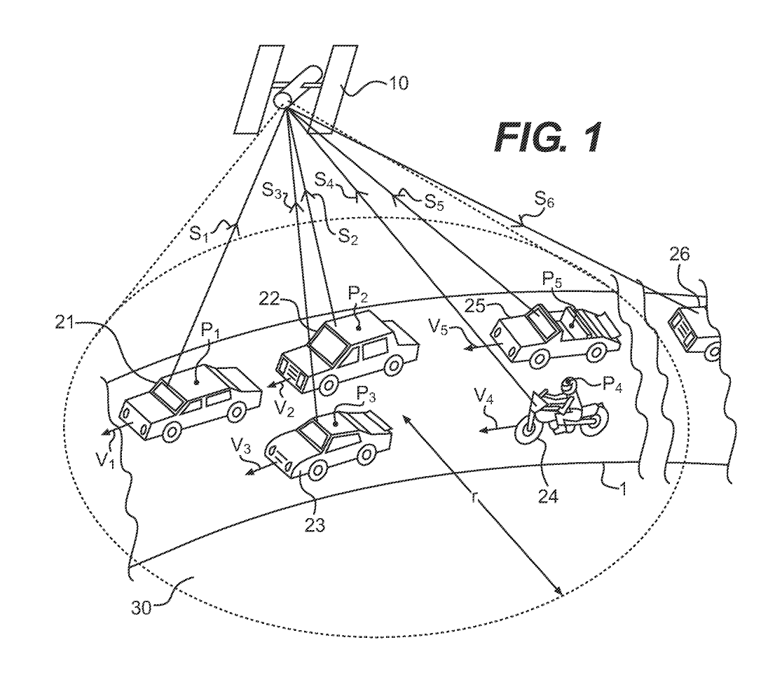

FIG. 1 shows a navigation system for a motor vehicle with reference to current traffic conditions in accordance with the subject matter. On a road 1, sampling vehicles 21-25 are running with different velocities V1-V5, respectively, which are being followed by a user vehicle 26. The term “sampling vehicles” borrowed from Statistics does not mean that the vehicles are picked at random, but only that they do not travel on a predetermined path. For example, sampling vehicles 21-25 may include taxis, police cars or any other vehicles equipped with reporting devices. Carried by each of the sampling vehicles 21-25 and the user vehicle 26 is a navigation unit (not shown) in which a Global Positioning System (GPS) module, a Radio Frequency (RF) transmitter, or any other kinds of wireless signaling module is installed. For example, the navigation unit can be an independent navigation device, a mobile telephone or a mobile internet device. A mobile internet device such as a “Droid®” type phone installed with an application that enables the user to find out the GPS position every x units of time and calculate the direction and/or speed can be the navigation unit according to the present subject matter. Each navigation unit in the vehicle 21-26 communicates with a signal transceiver 10 by trading signals S1-S6 therebetween. The signal transceiver 10 can be a satellite, an aircraft, or a signal control station either on the ground or in the air, including wired/wireless internet module. In case that a mobile internet device is used as the navigation unit, then an internet server such as a management zone server can make an analogue/digital link to a mobile internet device through wired/wireless internet communication.

The signal transceiver 10 determines a specific area 30 in a route to a destination desired by a driver of the user vehicle 26 and defines the sampling vehicles 21-25. Here, the specific area 30 can be defined by its radius R, or a sampling block (not shown) having a predetermined length along a route on which the sampling vehicles 21-25 are. Alternatively, the specific area 30 can be a Zone in a navigation route between a starting (or current) point and an ending point, which is well defined in the art as a standard unit in the navigation route.

It appears practically impossible to collect, store and update information on all sections of roads even in a moderately large area where the numbers may run into hundreds of thousands or even millions, so the present invention proposes a division of all roads in a given geographical area into two basic road categories: Category A consisting of all main roads; and Category B containing all roads not in category A. A more sophisticated division could be done by a more complex classification algorithm that performs classification based on type, maximum allowed speed, road length, road width, average traffic volume, registered average traffic volume (if available). Such an algorithm will have an obvious advantage of being able to perform automatic classification. All the databases in the sampling vehicles 21-25 and user vehicle 26 are updated from the signal transceiver 10 on a regular basis. These updates are done for both statistical (empirical) travel times and current travel times. It seems logical while planning a route to use different travel times in different locations, in particular, to use current travel times in the vicinity of the present position of the user vehicle 26, and at the same time to use statistical travel times elsewhere.

The signal transceiver 10 receives signals S1-S5 from the sampling vehicles 21-25 that include their velocity information V1-V5 and/or their positional information P1-P5, and forwards the signals S1-S5 to the navigation unit mounted on the motor vehicle 26. Then, the navigation unit computes the received velocity information data V1-V5 and P1-P5 to yield a reference value, which is a number proportional to the incident traffic flow of the sampling vehicles 21-25 at a specific time point. When obtaining and/or computing the velocity information V1-V5 and/or the positional information P1-P5, the information associated with the opposite traffic can be excluded. For example, if the user vehicle 26 runs along a freeway with a two-way traffic, the velocity information or the positional information regarding the opposite traffic will not be counted for deciding the optimal route.

The reference value is then compared with a predetermined value representing a normal traffic flow, which is determined based on the statistical data stored in the navigation unit. If the reference value is smaller than the predetermined value, the navigation unit recognizes it as a traffic incident in the route and issues a warning. For example, if the present traffic flow in the area of consideration, in which the sampling vehicles 21-25 run, is calculated as 5.6 based on the real time data, then the reference value of the area is 5.6. Then, this reference value is compared to the numerical value that indicates a normal traffic flow of the area, i.e., the predetermined value, 6.7, which is stored in the navigation unit. Since the reference value 5.6 is smaller than the predetermined value 6.7, the navigation unit may conclude that a traffic incident occurred in the area and issues a warning. The way of issuing the warning can be a visual symbol, an alarming sound, a vibration, a voice notification, or any combination thereof.

The sampling vehicles 21-25 can be three or more vehicles, whose velocity information V1-V5 and positional information P1-P5 may be in the form of velocity vectors and positional vectors, respectively.

The traffic incident can be, but not limited to, one of the following: 1) Temporary changes in road conditions known in advance like closed roads under construction, traffic reroutes, etc.; 2) Regular predictable changes like everyday slowdowns in rush hours; and 3) Sudden unpredictable changes such traffic accidents, traffic congestion due to sudden and drastic changes in traffic arrangements because of visiting dignitaries, etc.

Optionally, the current traffic flow of an area ahead of the user vehicle along the desired route may not be considered or calculated if an estimated time for the user vehicle to arrive at the area is so long enough that the current traffic flow at the area is expected not to be maintained by the time the vehicle arrives at the area. For example, if the user vehicle is running 50 miles ahead of an area in the desired route, with velocity of 50 miles/hour, where the navigation unit becomes aware that a traffic incident has happened and the calculation shows that the estimated time for clearing the incident about 30 minutes, then the navigation unit may continue with the originally suggested route, rather than suggesting an alternative route, because by the time the user vehicle arrives at the area in consideration the traffic flow will be restored to normal. For this function, the navigation unit can simply divide the desired route into a plurality of road segments without calculating the estimated arriving time to the incident area. For example, a first road segment is set for 0-5 miles ahead of the user vehicle; a second road segment is set for 5-10 miles; a third road segment is set for 10-15 miles; and so on. Based on this simplified division of the road, the unit can provide the driver with traffic information associated only with several nearest road segments while tentatively ignoring information on the farther segments.

Alternatively, the navigation unit can initially calculate the optimal route based on the statistical traffic data and/or the current time traffic data in association with the route, and then recalculate to reflect only the current time traffic data of the nearest road segments, e.g., segments for 0-15 miles, from the moving user vehicle.

Travel speeds along roads of various types can be obtained from the maximum allowed travel speed and by multiplying it by corresponding speed coefficients, so that traveling along any particular road is assumed to be done with a speed pertinent to the type of that road. The resulting speeds will be called the theoretical speeds, and the corresponding coefficients will be stored in a database in advance and provided on request. However, theoretical speeds are relevant only to ideal cases and will be probably never utilized except between midnight and early hours in the morning and even then under particularly favorably conditions. There are many reasons for this such as traffic congestion in rush hours, less than perfect road conditions, unfavorable whether conditions, falling trees, public gatherings, demonstrations, and probably a host of other factors that are difficult to enumerate. For route planning, the present navigation system uses empirical statistical travel times instead of theoretical travel times. These empirical travel times are preserved in the form of empirical speed coefficients by which the maximum allowed speeds should be multiplied.

Also it should be appreciated that a traffic incident can be calculated lane by lane so that the driver of the user vehicle can be prepared before arriving at the traffic of the lane in consideration. For this function, the navigation unit first identifies what kind of incident is that: for example, a simple slow-down, a serious car accident, a road construction, a temporary stop of a car, etc. This identification can be done by analyzing the pattern of the traffic flow in the lane in consideration. For example, in case of a car accident or a road construction, there will be no flow in the lane and every sampling vehicle must switch to the next lane. On the other hand, in case of a simple slow-down, there will be traffic flow, though slow, in the lane and switching to the next lane will occasionally occur. Based on the identified type of the incident, the navigation unit can issuing a warning whether to stay put in the current lane, or to simply slow down, or to switch to the next lane, among others. Optionally, when identifying type of traffic incident, the navigation unit can simply reflect only the traffic flow in the nearest segments, e.g., 0-15 miles.

The navigation system can be operated using both digital and analog systems. Also, the system can additionally include an automatic braking system that enables the user vehicle to automatically stop when it detects very slow traffic or stopped vehicles within a very short range in the same lane ahead of the vehicle. This automatic braking system can brake the vehicle quicker than the human reaction, to thereby prevent traffic accidents caused by unexpected traffic conditions ahead of the vehicle.

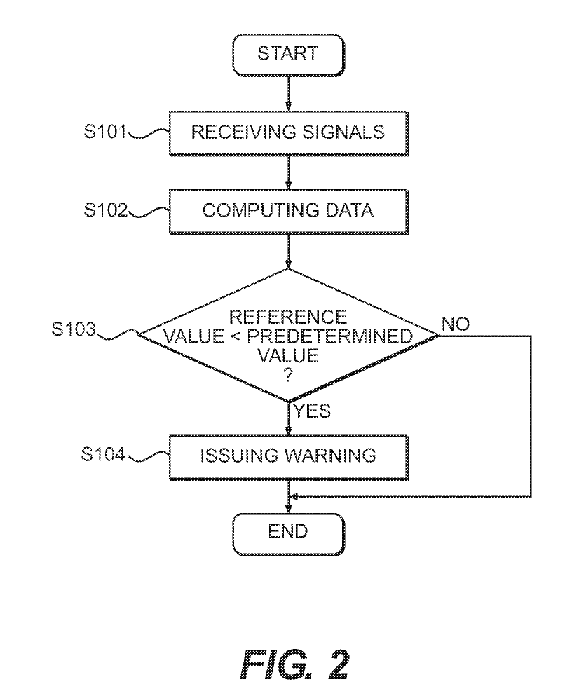

FIG. 2 is a flow chart that shows issue of a warning if there is a traffic incident in a route to a destination desired by a driver. Upon receiving signals from the transceiver S101, the navigation unit computes data information stored in the received signals to yield a reference value S102. The computation S102 can be performed for the current velocity information data and/or the current positional information data of the sampling vehicles in the area. In step S102, the reference value can be derived from an average value of the current velocities of the sampling vehicles in the area; a lowest value among the current velocities of the sampling vehicles in the area; an average value of lowest n velocities among the current velocities of the sampling vehicles in the area; or any combination thereof. Alternatively, in step S102, the computation of the data information can be implemented to obtain the reference value that can be derived from an average value of distances between the sampling vehicles in the area; a lowest value among the distances between the sampling vehicles in the area; an average value of lowest n distances among the distances between the sampling vehicles in the area; or any combination thereof. The sampling vehicles can be sampled in such a way that the sampling vehicles do not include a stopped vehicle.

Then, the reference value obtained in step S102 is compared with a predetermined value, generally representing normal traffic flow in the route, which is calculated based on historical and/or statistical traffic data with regard to the route at that time. Here, the volume of relevant calculation can be kept under control. If the reference value is smaller than the predetermined value, the navigation unit issues a warning of a traffic incident in the area S104. As previously mentioned, the way of issuing the warning can be a visual symbol, an alarming sound, a vibration, a voice notification, or any combination thereof. On the other hand, if the reference value is equal to or greater than the predetermined value, the navigation unit does not issue the warning.

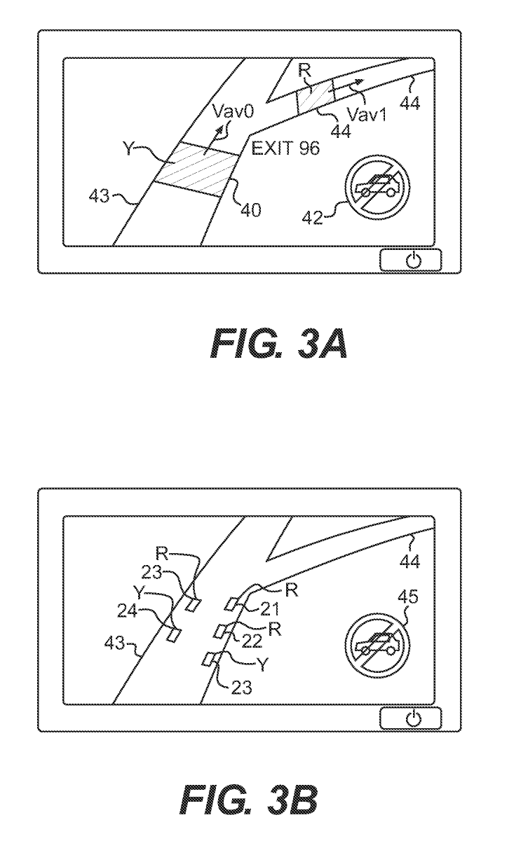

FIG. 3A shows a navigation unit in accordance with the subject matter, which displays an area with a single color based on an average velocity of sampling vehicles. On the display of the navigation unit, a first slow area 40 in a main road 43, in which the sampling vehicles are slower than normal due to traffic congestion, is indicated as solid Yellow Y. In the first slow area 40, the average speed of the sampling vehicles in the area 40 is Vav0. Also, there is a second slow area 41 in another road 44 bifurcated from the main road 43, in which the sampling vehicles are significantly slower than normal because of a traffic accident. The second slow area 41 is indicated with solid Red R as the average speed Vav1 of the sampling vehicles in the second slow area 41 is even lower than that Vav0 of the first slow area 40. In general, if average velocity of the sampling vehicles in the area in consideration is smaller than a predetermined value that is determined based on a normal velocity in the area at that time, the navigation unit can issue a warning such as a visual symbol 42. The visual symbol 42 advises the driver not to enter the branch road 44 within a predefined time. In lieu of or with the visual symbol 42, an alarming sound, a vibration, a voice notification, or any combination thereof can be used.

FIG. 3B shows a navigation unit that displays the sampling vehicles with visual objects of different colors depending upon a speed zone to which each vehicle belongs. In FIG. 3B, the navigation unit can display the sampling vehicles separately with different colors as schematically shown. The sampling vehicles are indicated with separate visual objects having different colors. Each visual object can be a graphic indicator displayed by the navigation unit and represents corresponding sampling vehicle. A color of each sampling vehicle is determined by a speed zone to which the sampling vehicle belongs. For example, any two sampling vehicles have a same color if they belong to a same speed zone while two vehicles have different colors if they belong to different speed zones. Speed zones can be determined in consideration of the speed limit and/or normal velocity of cars in the area, a predefined minimum velocity, etc. Alternatively, each speed zone can have a fixed speed range, e.g., 5, 10, 15, or 20 MPH.

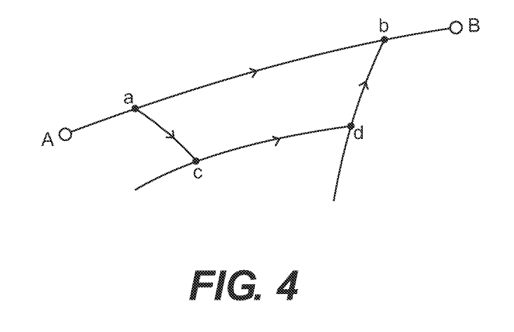

FIG. 4 shows a primary route to a desired destination computed based on statistical data stored in the navigation unit, and an alternative route to the destination computed based on both the statistical data stored in the navigation unit and real-time traffic data obtained from a transceiver. A driver is supposed to begin his car trip from a start point A to a destination point B. In a route to the destination B, which is calculated by the navigation unit based on historical and/or statistical data of the traffic between the start point A and the destination point B, a road segment from a first point a to a second point b (“segment a-b”) is a region in consideration. In a normal traffic condition, the segment a-b would be a shortest-time route between the points a, b. However, if a traffic incident such as car accident or traffic congestion occurs on the segment a-b, making a detour may be proved to be a faster way to the point b. According to an embodiment of the subject matter, the navigation unit can calculate a shortest-time route using not only the historical and/or statistical data with regard to the route to the desired destination, which is already stored in the navigation unit, but also the real-time traffic data obtained from the transceiver. If an estimated travel time T1 along the segment a-b, in which the incident occurred, is equal to or greater than the corresponding time T2 along an alternative route between the points a, b, composed of three segments a-c, c-d, and d-b, the navigation unit recommends this alternative route to the driver. The estimation of travel time will be implemented by the navigation unit throughout all of the traffic segments between the start point A and the destination point B using both of the stored data and the real-time data.

In view of the above it would also be advantageous to make available the navigation system according to the present subject matter to the mass-market hand-held wireless devices. In order to accomplish this, several changes would have to be incorporated into the present patent structure. Both the data processing and route planning previously executed at the signal transceiver are now transferred to the Internet server database. The main load of processing data and computation of optimal routes now rests on the server. This will require expanded server capabilities and computation time. Due to frequent client requests and entries, a new information management application will have to be developed which will enable the signal transceiver to deal with increased information traffic.

As pointed above, due to the limitations of all of these wireless mobile navigation units there is a growing need for introduction of new wireless application protocols (WAP). Naturally, the WAP protocol requires adaptation of the communication modules and server applications. However, as this protocol becomes more widespread in the industry, seamless integration of the major functions of the proposed system will be achieved. Guidance System Mobile (GSM)-based mobile phone development enables the transfer of position information within reasonable degree of accuracy and therefore can replace the previous GPS standard. By accessing this data, the Internet Server maintains database and can process all individual requests in real time. Calculated route is then transferred via Internet/WAP application code to the user. Due to the size limitations of the cell-phone LCD displays, it will be desirable to provide an independent on-vehicle A/V color monitor with full connection capabilities to the cell-phone. It should be noted that in this refinement any client vehicle with a cell-phone can function as sample vehicle.

Although the subject matter has been described with reference to the illustrated embodiment, the subject matter is not limited thereto. The subject matter being thus described, it will be obvious that the same may be varied in many ways. Such variations are not to be regarded as a departure from the spirit and scope of the subject matter, and all such modifications as would be obvious to one skilled in the art are intended to be included within the scope of the following claims.

1. A method of navigating a motor vehicle with reference to current traffic conditions in an area, comprising:
transmitting signals by a signal transceiver to a navigation unit in the motor vehicle, the signals including at least one selected from the group consisting of (a) current velocity information of sampling vehicles in the area and (b) current positional information of the sampling vehicles in the area;
computing, by the navigation unit, a reference value as a number proportional to traffic incident flow of at least one vehicle at a specific time based upon at least one of the current velocity information and the current positional information;
identifying a traffic incident, by the navigation unit, based on data computations made by the navigation unit; and
issuing, by the navigation unit, a warning of a traffic incident in the area if the reference value is smaller than a predetermined value that represents at least one of historical velocity information and historical positional information associated with the area in a normal traffic condition.

2. The method according to claim 1, further comprising:
displaying current velocities of the sampling vehicles based on the current velocity information, wherein any two sampling vehicles in the area are displayed with two visual objects of a same type if their velocities belong to a same speed zone, and the two sampling vehicles are displayed with two visual objects of two different types if their velocities belong to different speed zones.

3. The method according to claim 2, wherein the two visual objects of two different types have two different colors.

4. The method according to claim 1, wherein the warning includes at least one selected from the group consisting of: (a) a visual symbol; (b) an alarming sound; (c) a vibration; and (d) a voice notification.

5. The method according to claim 1, wherein the reference value is computed based on at least one value selected from the group consisting of:
(a) an average value of the current velocities of the sampling vehicles in the area;
(b) a lowest value among the current velocities of the sampling vehicles in the area; and
(c) an average value of lowest n velocities among the current velocities of the sampling vehicles in the area.

6. The method according to claim 1, wherein the reference value is computed based on at least one value selected from the group consisting of:
(a) an average value of distances between the sampling vehicles in the area;
(b) a lowest value among the distances between the sampling vehicles in the area; and
(c) an average value of lowest n distances among the distances between the sampling vehicles in the area.

7. The method according to claim 1, wherein the signals include the current velocity information of the sampling vehicles in the area, and the step of computing a reference value by the navigation unit is performed for the current velocity information, the method further comprising:
determining an optimal route to a desired destination by the navigation unit, wherein an estimated travelling time along the optimal route has a lowest value compared to estimated travelling times along a plurality of alternative routes to the destination, the estimated travelling time along the route being calculated by the navigation unit based on statistical traffic data for the route and the reference value; and
displaying the optimal route to the desired destination.

8. The method according to claim 1, wherein the signal transceiver is a satellite and the navigation unit is installed with a Global Positioning System (GPS) module.

9. The method according to claim 5, wherein the area is located at a predetermined distance ahead of the motor vehicle in a route, and the warning is issued, the method further comprising:
transmitting speed control signals to the motor vehicle by the navigation unit to instruct the motor vehicle to adjust its velocity to a lower speed that is equal to or within a predetermined deviation from the reference value.

10. The method according to claim 5, further comprising displaying the area by the navigation unit with a single color that is determined based on the current velocity information of the sampling vehicles.

11. The method according to claim 1, wherein the area is a zone in a navigation route between a starting point and an ending point, the area being defined as a standard unit in the navigation route.

12. The method according to claim 1, wherein the current velocity information includes positive velocities associated with a first group of the sampling vehicles in a same traffic direction as the user vehicle in a two-way traffic and negative velocities associated with a second group of the sampling vehicles in an opposite traffic in the two-way traffic,
wherein the current positional information includes positive positions associated with the first group of the sampling vehicles and negative positions associated with the second group of the sampling vehicles,
wherein the computation of the reference value by the navigation unit based upon at least one of the current velocity information and the current positional information excludes the negative velocities and the negative positions.

13. The method according to claim 1, wherein the signal transceiver is an internet server and the navigation unit is a mobile internet device including a non-transient computer-readable medium that stores an application, which is executable to tap into GPS position of the sampling vehicles at every predetermined unit of time and calculate directions and speeds of the sampling vehicles.

14. The method according to claim 13, wherein the internet server and the navigation unit make an analogue or digital link using a wired or wireless internet communication.

15. A method of navigating a motor vehicle, comprising:
receiving signals that include at least one selected from the group consisting of (a) current velocity information of sampling vehicles in an area and (b) current positional information of the sampling vehicles in the area;
computing, by the navigation unit, a reference value as a number proportional to traffic incident flow of at least one vehicle at a specific time based upon at least one of the current velocity information and the current positional information;
identifying a traffic incident, by the navigation unit, based on data computations made by the navigation unit; and
issuing a warning of a traffic incident in the area if the reference value is smaller than a predetermined value that represents at least one of historical velocity information and historical positional information associated with the area in a normal traffic condition.

16. A motor vehicle navigating system, comprising:
a signal transceiver that is configured to transmit signals to a motor vehicle, the signals including at least one selected from the group consisting of (a) current velocity information of sampling vehicles in the area and (b) current positional information of the sampling vehicles in the area; and
a navigation unit connected to the motor vehicle, which comprises a non-transitory computer-readable medium that stores data for implementing:
computing, by the navigation unit, a reference value as a number proportional to traffic incident flow of at least one vehicle at a specific time based upon at least one of the current velocity information and the current positional information;
identifying a traffic incident, by the navigation unit, based on data computations made by the navigation unit; and
issuing a warning of a traffic incident in the area if the reference value is smaller than a predetermined value that represents at least one of historical velocity information and historical positional information associated with the area in a normal traffic condition.

17. The system according to claim 16, wherein the non-transitory computer-readable medium further stores data for implementing:
displaying current velocities of the sampling vehicles based on the current velocity information such that any two sampling vehicles in the area are displayed with two visual objects of a same type if their velocities belong to a same speed zone, and the two sampling vehicles are displayed with two visual objects of two different types if their velocities belong to different speed zones.

18. The system according to claim 16, wherein the warning includes at least one selected from the group consisting of: (a) a visual symbol; (b) an alarming sound; (c) a vibration; and (d) a voice notification.

19. The system according to claim 16, wherein the signals include the current velocity information of the sampling vehicles in the area, and the step of computing is implemented for the current velocity information, wherein the non-transitory computer-readable medium further stores data for implementing:
determining an optimal route to a desired destination by the navigation unit such that an estimated travelling time along the optimal route has a lowest value compared to estimated travelling times along a plurality of alternative routes to the destination, the estimated travelling time along the route being calculated by the navigation unit based on both statistical traffic data for the route and the reference value; and
displaying the optimal route to the desired destination.

20. The system according to claim 19, wherein the area is located at a predetermined distance ahead of the motor vehicle in a route, and the reference value is smaller than the predetermined value, the non-transitory computer-readable medium further stores data for implementing:
transmitting speed control signals to the motor vehicle to instruct the motor vehicle to adjust its velocity to a lower speed that is equal to or within a predetermined deviation from the reference value.
